(19) United States
(12) Patent Application Publication
(10) Pub. No.: US 2024/0058728 A1
(43) Pub. Date: Feb. 22, 2024

(54) LIQUID FILTERING BAG

(71) Applicant: Todd Ewing, Walnut Creet, CA (US)

(72) Inventor: Todd Ewing, Walnut Creet, CA (US)

(21) Appl. No.: 18/384,350

(22) Filed: Oct. 26, 2023

Related U.S. Application Data
(63) Continuation of application No. 17/832,501, filed on Jun. 3, 2022.

(51) Int. Cl. B01D 29/27; B01D 29/09; B01D 29/62

(52) U.S. Cl. CPC B01D 29/27; B01D 29/093; B01D 29/62

(57) ABSTRACT

A liquid filtering bag comprises a liquid-permeable fabric and zipper. When the zipper is fully engaged, the fabric folds to form a liquid filtering bag suitable for filtering liquids. When the zipper is fully disengaged, the fabric unfolds to form a flat sheet suitable for thorough washing.

### CROSS REFERENCE TO RELATED APPLICATIONS

This application is a continuation application to U.S. application Ser. No. 17/832,501, filed on Jun. 3, 2022 and entitled LIQUID FILTER BAG, the entire contents of which is hereby incorporated by reference in its entirety.

### BACKGROUND

The liquid filtering bag is an important device used in the preparation of many beverages such as cold-brewed coffee, nut milk, and juice. A liquid filtering bag is also an important device used in the preparation of infused oils. Reusable liquid filtering bags are typically manufactured from fabrics that allow them to be washed and reused many times.

Those skilled in the art find that currently available reusable liquid filtering bags suffer from limitations related to gradual fouling and clogging and consequent loss of efficacy. During the filtering process, solid particles, fats and waxes become lodged inside the meshwork of the filtering bag. As the meshwork accumulates debris, the effective size of the pores decreases, resistance to flow increases, and the filtering performance of the filtering bag degrades.

There are various ways to wash a reusable filtering bag to remove embedded debris and restore filter performance. Handwashing can partially restore filter performance, though handwashing is labor intensive, requires manual turning inside-out, exposes the operator to skin-irritating detergents, and requires multiple cycles of washing and rinsing. After handwashing the filtering bag, subsequent machine washing can further remove embedded debris, but machine washing typically fails to fully restore the performance of the filtering bag. As a result, those skilled in the art find that currently available reusable liquid filtering bags require significantly labor-intensive handwashing prior to machine washing and yet tend to steadily lose performance after every interval of filtering and washing and that after some number of intervals they need to be discarded.

In U.S. Pat. No. 9,919,247, Wettlaufer describes a seamless filter bag for a juice press. The open-top bag is formed by folding a single continuous sheet of fabric in half, then crimping the right and left sides with folds that are held in place with one or more belts. When said bag is unfolded, the single continuous sheet of fabric would be suitable for machine laundering. However, in operation, said bag is squeezed between two platens with up to seven tons of force which requires a large and expensive press that may only be suitable for a factory or store distributing bottled juice.

In U.S. Pat. No. 6,908,550, Silverstein describes a filter bag for a pool cleaning device with a zipper opening along one side. The zipper opening allows for temporary access to the interior of the bag to remove collected debris. Based on the described embodiments of the invention, it is anticipated that said bag would not be suitable for machine laundering.

In U.S. Pat. No. 10,743,557, Hampton et. al. describe a nutmilk extraction device utilizing an open-top filtering bag that is suspended inside an extraction chamber. The bag is twistably compressed by a twistable cap on the device. Based on the described embodiments of the invention, it is anticipated that said bag would not be suitable for machine laundering.

Despite the available art described in the patents, there remains a large unmet need for reusable liquid filtering bags that can conveniently process infused oils and beverages such as cold-brew coffee, nut milks, and juices and that can be more easily cleaned and more fully restored to their original filtering performance after every washing. There is also a large unmet need in commercial kitchens and restaurants for filtering bags that can be conveniently washed in a laundry machine and reused in a way that meets stringent sanitation regulations. Such a reusable filtering bag would help support and promote the current consumer demand for healthier, cold-brewed beverage and nut milk options.

### SUMMARY OF THE INVENTION

The present invention describes a reusable liquid filtering bag that can be disassembled to form a single continuous sheet of fabric and laundered in an automatic laundry washing machine. Said bag employs a continuous zipper along the bottom and side edge. When said zipper is fully engaged, the bottom and side edge of said bag are sealed to form an open-top filtering bag. When said zipper is fully disengaged, said edges are released and said bag opens to form a single continuous flat sheet of fabric.

It has been discovered that common zippers can be readily incorporated into embodiments of the invention without compromising filtering performance. For context, someone of ordinary skill in the art would likely anticipate the gap between opposing teeth of common zippers would permit filtered particulates to escape the filtering bag and degrade filtering performance. However, common zippers have been discovered to have such closely engaged opposing teeth that they not only block the escape of particulates, they also sustain this performance under elevated pressures induced by filtering presses.

It has also been discovered that laundering the bag in its unzipped, disassembled form facilitates sufficient removal of embedded debris that filtering performance is fully restored after laundering. For context, someone of ordinary skill in the art would likely anticipate that laundering the unzipped, disassembled filter would provide an incremental benefit in restoring filtering performance after laundering. Quite unexpectedly, embodiments of the invention appear to retain nearly complete filtering performance after many cycles of filtering and washing while conventional filtering bags made from the identical fabric lose significant filtering performance after a single cycle of filtering and washing.

In some embodiments of the present invention, filtering bags may be tall and narrow or may be short and wide. Embodiments may have a bottom zipper-fringed edge that is straight or rounded.

A deeper understanding of the nature and advantages of the present invention may be achieved by referring to the drawings and the remainder of the specification.

### BRIEF DESCRIPTION OF THE DRAWINGS

FIG. 1 shows a tall and narrow liquid filtering bag in an assembled open-top bag configuration with the zipper fully engaged. Said configuration represents the state during which said bag can be used to filter liquids.

FIG. 2 shows a tall and narrow liquid filtering bag in a disassembled flat-sheet configuration with the zipper fully disengaged. Said configuration represents the state during which said bag can be washed, dried, and stored.

FIG. 3 shows a short and wide liquid filtering bag in an assembled open-top bag configuration with the zipper fully engaged. Said configuration represents the state during which said bag can be used to filter liquids.

FIG. 4 shows a short and wide liquid filtering bag in a disassembled flat-sheet configuration with the zipper fully disengaged. Said configuration represents the state during which said bag can be washed, dried, and stored.

### SPECIFICATIONS

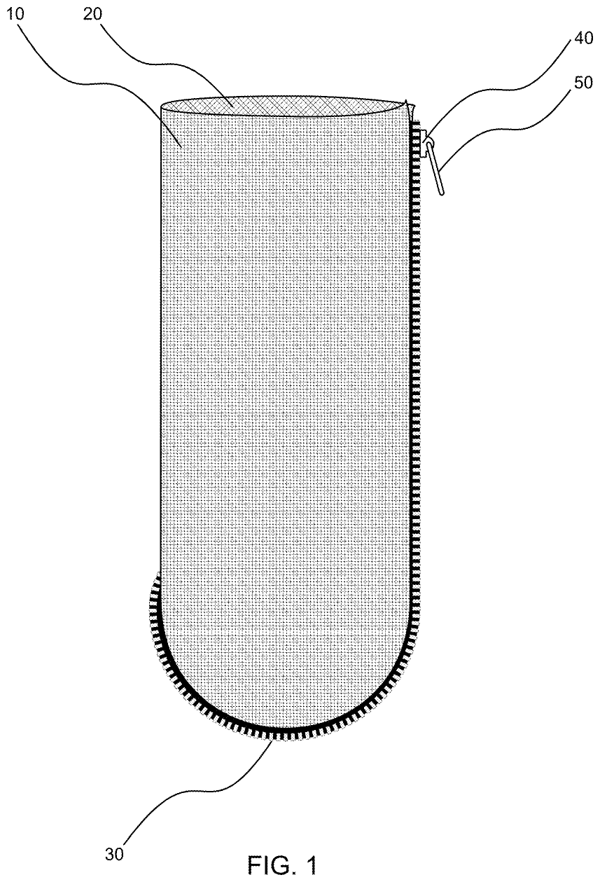

FIG. 1 shows a tall and narrow liquid filtering bag according to a preferred embodiment of the invention. Said bag is shown in an assembled open-top bag configuration representing the state during which said bag can be used to filter liquids. An outer surface 10 of said filtering bag exudes filtered liquid during filtering operation. An inner surface 20 of said bag receives unfiltered liquid and traps filtered particulates during filtering operation. A fully engaged zipper 30 forms the bottom and side edge of said filtering bag. A zipper slider 40 and puller 50 are configured to rest at the top edge of said bag when fully engaged.

In embodiments of the invention, the filter bag is made from mesh, fabric, non-woven fabric, fiber, cloth, cotton, nylon, polyester, or cotton paper. Said embodiments are fashioned with a mesh spacing selected from about 25-500 micrometers and preferably 70-150 micrometers. Said embodiments are configured with an open top further configured with one or more closure devices selected from the group comprising crimp, fold, flap, clamp, drawstring, zipper, and hook-and-loop fastener.

In embodiments of the invention, the zipper 30 may be selected from gauge sizes #3 up to #10. It was discovered that said zipper selected from these gauge sizes was sufficiently tightly engaged to prevent the escape of filtered particulates from between its teeth out of the bag into the filtered liquid.

In embodiments of the invention, tall and narrow filtering bags would be selected from sizes that can conveniently process about 200-10000 milliliters of unfiltered liquid and preferably 500-2000 milliliters of unfiltered liquid. Said embodiments have a height of about 200-900 millimeters and preferably 300-500 millimeters. Said embodiments have a width of about 100-500 millimeters and preferably 150-250 millimeters. Said embodiments have a height to width ratio of about 1.5 to 3 and preferably around 2.

It was discovered that when reduced to practice, a tall and narrow liquid filtering bag is ideally suited for many food and beverage filtering tasks when it is supported by a tall and narrow supporting pitcher common to most kitchens because the bag is less sufficiently stable to staying upright on its own during filling.

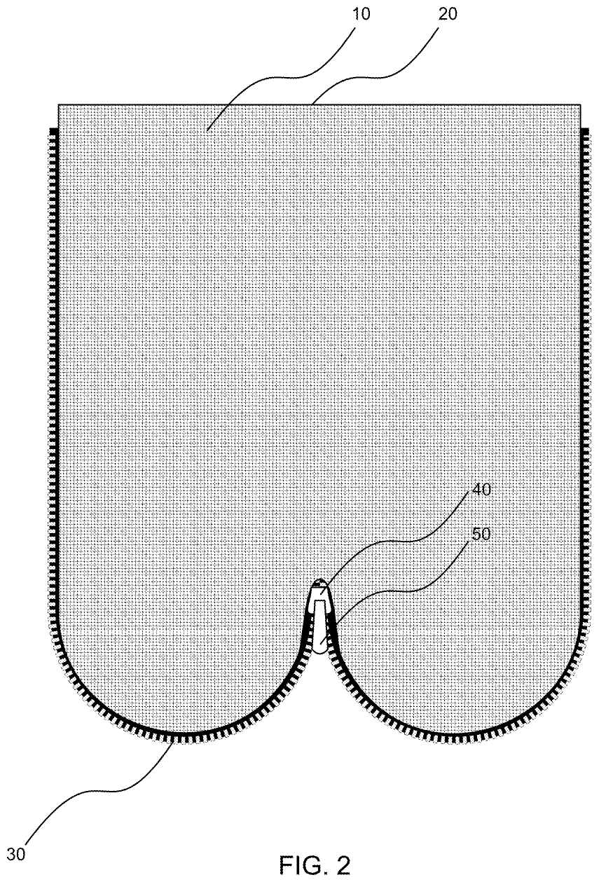

FIG. 2 shows a tall and narrow liquid filtering bag in a disassembled, flat-sheet configuration according to a preferred embodiment of the invention. The flat-sheet configuration represents the state during which said bag can be washed, dried, and stored. A visible, formerly outer surface 10 and hidden, formerly inner surface 20 are fully exposed to laundering agents and washing water during automatic machine washing. The fully exposed surfaces facilitate the unhindered release of trapped debris from said surface 20 directly into the bulk phase of washing water. A fully disengaged zipper 30 forms the bottom edge and both side edges of said disassembled filtering bag. A zipper slider 40 and puller 50 are configured to rest at the innermost center of bottom edge of said bag where the two opposing zipper edges remain connected when fully disengaged.

In preferred embodiments of the invention, disassembled filtering bags would be washable in an automatic washing machine without the need for extensive hand pre-washing. Said filtering bags would also be compatible with high-temperature washing, disinfection, and high-temperature drying in order to ensure proper sanitation for reuse in a commercial food establishment.

In embodiments of the invention, the disassembled, flat-sheet configurations of tall and narrow filtering bags have height of about 200-900 millimeters and preferably 300-500 millimeters. Said embodiments have a width of about 200-900 millimeters and preferably 300-500 millimeters. Said embodiments have a height to width ratio of around 0.75 to 1.5 and preferably around 1.

It was discovered that laundering the disassembled, flat-sheet configuration of filtering bags was far more effective than laundering of a conventional filtering bag; nearly all the original filtering performance of the filtering bag could be retained after every cycle of filtering, washing, and drying. The superior filtration performance of embodiments of the invention after washing has enabled their use with more challenging filtration tasks involving finer particulates, which, in turn, has enabled the development of unprecedented new techniques of cold brew beverage production involving much finer grinding and better flavor extraction from brewing materials than previously anticipated.

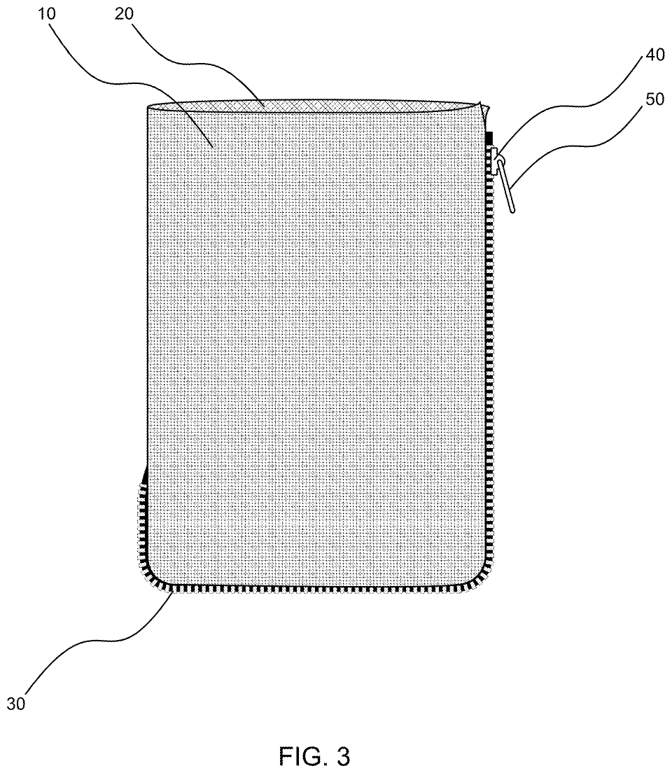

FIG. 3 shows a short and wide liquid filtering bag according to a preferred embodiment of the invention. Said bag is shown in fully assembled configuration representing the state during which said bag can be used to filter liquids. An outer surface 10 of said filtering bag exudes filtered liquid during filtering operation. An inner surface 20 of said bag receives unfiltered liquid and collects filtered particulates during filtering operation. A fully engaged zipper 30 forms bottom and side edge of said filtering bag. A zipper slider 40 and puller 50 are configured to rest at the top edge of said bag when fully engaged.

In embodiments of the invention, short and wide filtering bags would be selected from sizes that can conveniently process about 200-10000 milliliters of unfiltered liquid and preferably 500-2000 milliliters of unfiltered liquid. Said embodiments have a height of about 150-700 millimeters and preferably 200-400 millimeters. Said embodiments have a width of about 150-700 millimeters and preferably 200-400 millimeters. Said embodiments have a height to width ratio of about 0.75 to 1.5 and preferably around 1.

It was discovered that when reduced to practice, a short and wide liquid filtering bag is ideally suited for many food and beverage filtering tasks when it is supported by a flat pan or shallow pot common to most kitchens because the bag is more sufficiently stable to staying upright on its own during filling.

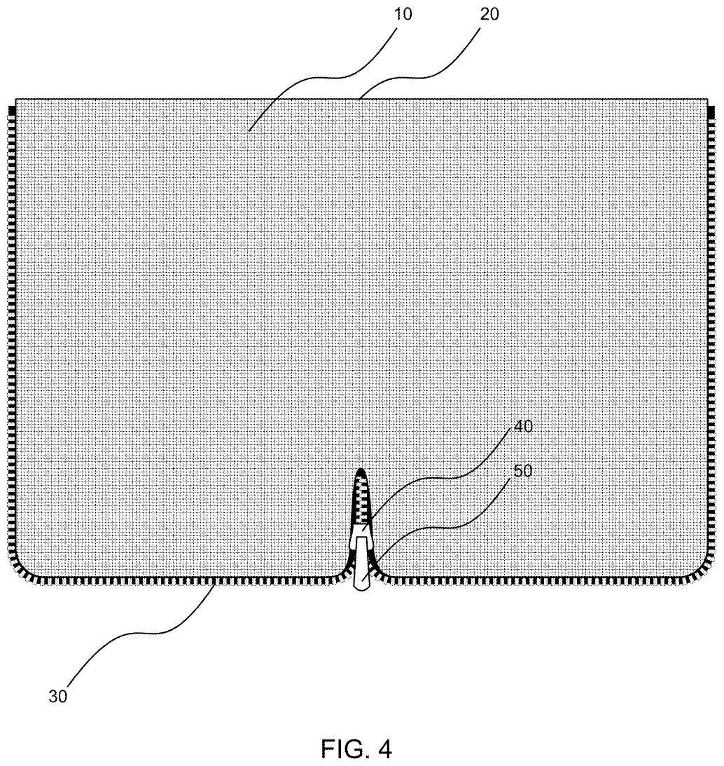

FIG. 4 shows a short and wide liquid filtering bag in a fully disassembled configuration representing the state during which said bag can be washed, dried, and stored. A visible, formerly outer surface 10 and hidden, formerly inner surface 20 are fully exposed to laundering agents and washing water during automatic machine washing enabling the complete release of trapped debris from said surface 20. A fully disengaged zipper 30 forms the bottom and both side edges of said disassembled filtering bag. A zipper slider 40 and puller 50 are configured to rest at the innermost center of bottom edge of said bag where the two opposing zipper edges remain connected when fully disengaged.

In embodiments of the invention, short and wide filtering bags in a fully disassembled configuration have a height of about 150-700 millimeters and preferably 200-400 millimeters. Said embodiments have a width of about 300-1300 millimeters and preferably 500-700 millimeters. Said embodiments have a height to width ratio of about 0.25 to 0.75 and preferably around 0.5.

While the above text and accompanying figures are a complete description of specific embodiments of the invention, they should not be taken as limiting the scope of the invention as defined by the claims. For instance, the filtering bags described by this invention could be implemented for the separation of any solid and liquid mixture that may or may not be beverage or aqueous. The filtering bags could be implemented to operate at any given temperature and pressure.

1. A method to filter a liquid using a liquid filter bag, comprising:
providing a liquid filter bag in a pouch configuration comprising:
an opening; and
a body portion comprising a first side disposed opposite a second side and a bottom portion disposed opposite a top portion, wherein the body portion further comprises:
a single unitary sheet of liquid-permeable fabric; and
a zipper with engaged zipper profiles disposed on the first side, the bottom portion, and a portion of the second side proximal to the bottom portion, and a zipper slider disposed at a first terminal end of the zipper on the first side proximal to the top portion;
pouring a liquid containing particulates into the opening of the liquid filter bag;
collecting the filtered liquid passing through the liquid filter bag; and
disengaging the zipper to form the liquid filter bag into a sheet configuration that is machine-washable to remove debris from the liquid-permeable fabric

2. The method of claim 1, further comprising:
washing the sheet configuration of the liquid filter bag;
drying the sheet configuration of the liquid filter bag;
folding the sheet configuration of the liquid filter bag; and
zipping the liquid filter bag to form the pouch configuration.

3. A liquid filter sheet configured to become a filter bag in a pouch configuration to filter particulates from a liquid, the sheet configuration comprising:
a single unitary liquid-permeable fabric sheet having a bottom edge connecting two opposite sides, and a top edge;
a zipper having a gauge size between #3 and #10, the zipper comprising two interlocking faces, wherein the interlocking faces are joined at a base of a notch, the notch positioned perpendicular to and a distance from the bottom edge, wherein each interlocking face extends from the notch along opposite halves of the bottom edge and along the opposite sides to top terminal positions proximal to the top edge;
wherein the zipper is operable, when a zipper slider is positioned at the notch, to form the sheet configuration into a pouch configuration by moving the zipper slider in a first direction from the notch to the top terminal positions and joining the two interlocking faces, and to transform the pouch configuration back into a sheet configuration by moving the zipper slider in a direction opposite the first direction to unlock the interlocking faces;
wherein the opening of the pouch configuration comprises a closure device; and
wherein the sheet configuration is machine-washable to remove filterable particulates from the liquid-permeable fabric.

4. The liquid filter sheet of claim 3, wherein the pouch configuration comprises:
a height from the bottom edge to the top edge is in a range of 200 to 900 millimeters;
a width from a first side to a second side that is in a range of 100 to 500 millimeters, wherein the first side is disposed opposite the second side; and
a height to width ratio is in a range of 1.5 to 3.

5. The liquid filter sheet of claim 4, wherein in the pouch configuration comprises:
the height is in the range of 250 to 500 millimeters;
the width is in the range of 120 to 250 millimeters; and
the height to width ratio is around 2.

6. The liquid filter sheet of claim 3, wherein the pouch configuration comprises:
a height from the bottom edge to the top edge in a range of 100 to 800 millimeters;
a width from a first side to a second side in a range of 100 to 800 millimeters, wherein the first side is disposed opposite the second side; and
a height to width ratio in a range of 0 75 to 1.5.

7. The liquid filter sheet of claim 6, wherein the pouch configuration comprises:
the height from the bottom edge to the top edge in a range of 150 to 400 millimeters;
the width from a first side to a second side in a range of 150 to 400 millimeters; and
the height to width ratio is around 1.

8. The liquid filter sheet of claim 3, wherein the closure device is one of a fold, a flap, a clamp, a drawstring, another zipper, or a hook-and-loop fastener.

9. The liquid filter sheet of claim 3, wherein the liquid-permeable fabric is one or more of mesh, woven fabric, non-woven fabric, fiber, cloth, cotton, nylon, polyester, and cotton paper.

10. The liquid filter sheet of claim 9, wherein the liquid-permeable fabric comprises a mesh, and wherein the mesh comprises mesh spacing in a range of 25 to 500 micrometers.
